(19) United States
(12) Patent Application Publication
(10) Pub. No.: US 2016/0246887 A1
(43) Pub. Date: Aug. 25, 2016

(54) APPARATUS AND METHOD OF OPERATING CUSTOMIZED PROPOSAL SERVICE

(71) Applicant: Samsung Electronics Co., Ltd., Suwon-si (KR)

(72) Inventors: Sangyong LEE, Seongnam-si (KR); Chiyong KANG, Suwon-si (KR); Minsung KIM, Seoul (KR)

(21) Appl. No.: 15/014,406

(22) Filed: Feb. 3, 2016

(30) Foreign Application Priority Data
Feb. 24, 2015 (KR) 10-2015-0026085

(51) Int. Cl. G06F 17/30

(52) U.S. Cl. CPC G06F 17/30867; G06F 17/30598; G06F 17/3053

(57) ABSTRACT

An apparatus and method for operating a customized proposal service are provided. The apparatus includes a database (DB) configured to store use pattern information about one or more client devices, a communication module configured to communicate with the one or more client devices, and a processor configured to provide recommended information for a proposal service field based on a use pattern of a first client device, provide a second client with modified recommended information by reflecting feedback information when the feedback information about the provided recommended information is received from the first client device, and receive feedback information about the modified recommended information from the second client and evaluate the recommended information and the modified recommended information.

### CROSS-REFERENCE TO RELATED APPLICATION(S)

This application claims the benefit under 35 U.S.C. §119(a) of a Korean patent application filed on Feb. 24, 2015 in the Korean Intellectual Property Office and assigned Serial number 10-2015-0026085, the entire disclosure of which is hereby incorporated by reference.

### TECHNICAL FIELD

The present disclosure relates to an apparatus and a method of operating a customized proposal service based on data.

### BACKGROUND

According to the development of the Internet and mobile devices, and an increase in Internet and mobile device users, data has been more rapidly and variously accumulated, and thus, an analysis of the data has become more difficult and complicated. Recently, proposal services for searching for an optimum value (for example, contents, a product, and an item) that is suitable to the demands of a user by analyzing a pattern of a user, analyzing the user in various aspects, and recommending the searched value to the user, have been researched in various fields.

The above information is presented as background information only to assist with an understanding of the present disclosure. No determination has been made, and no assertion is made, as to whether any of the above might be applicable as prior art with regard to the present disclosure.

### SUMMARY

In general, when a searching space is limitlessly large, in order to search for an optimum value in a searching system, a process of receiving lots of feedback from a client during a process, in which data is changed, is required. In this case, when the searching system continuously requests the feedback from the same client, the client may feel cumbersome and inconvenienced according to the request of the feedback.

Aspects of the present disclosure are to address at least the above-mentioned problems and/or disadvantages and to provide at least the advantages described below. Accordingly, an aspect of the present disclosure is to provide an apparatus and a method of operating a customized proposal service, which are capable of providing and operating a proposal service in accordance with a characteristic and a tendency of a user without continuously receiving feedback from a specific client in an infinite searching space.

In accordance with an aspect of the present disclosure, an apparatus for operating a customized proposal service is provided. The apparatus includes a database (DB) configured to store use pattern information about one or more client devices, a communication module configured to communicate with the one or more client devices, and a controller configured to provide recommended information for a proposal service field based on a use pattern of a first client device, provide a second client device with modified recommended information by reflecting feedback information when the feedback information about the provided recommended information is received from the first client device, and receive feedback information about the modified recommended information from the second client device and evaluate the recommended information and the modified recommended information.

In accordance with another aspect of the present disclosure, a method of operating a customized proposal service is provided. The method includes transferring recommended information, which is generated for a proposal service field, based on use pattern information of clients communicating a proposal service operating apparatus, to one or more clients, receiving feedback information for the recommended information from a first client among the one or more clients, to which the recommended information is transferred, generating modified recommended information by reflecting the feedback information, transferring the generated modified recommended information to a second client among the one or more clients, and receiving feedback information for the modified recommended information from the second client.

In accordance with another aspect of the present disclosure, a method of operating a proposal service by an electronic device is provided. The method includes receiving recommended information from a proposal service apparatus in response to a recommended information request event, providing the recommended information, and when feedback information about the recommended information is detected from a user, transferring the received feedback information to the proposal service apparatus.

The apparatus and the method of operating the customized proposal service according to various embodiments of the present disclosure may receive feedback about recommended information generated by a cluster classified to have a similar tendency in an infinite searching space, thereby searching for an optimum value customized to a user. The present disclosure may improve a user experience (UX) environment while directly/indirectly using a system, a product, and a service, and increase the occurrence of serendipity (unexpected good recommended information) deviating from a similar pattern. Accordingly, a user may experience various information from other users who have a similar tendency, and receive recommended information deviating from the characteristics and the history of the user, thereby expanding interests in more various information.

Further, the present disclosure may be applied to the Internet of Things and a smart home service, thereby improving convenience of a user.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other objects, features, and advantages of certain embodiments of the present disclosure will be more apparent from the following description taken in conjunction with the accompanying drawings, in which:

FIG. 1 is a diagram illustrating a configuration of a system including an apparatus for operating a customized proposal service according to various embodiments of the present disclosure;

FIG. 2 is a diagram illustrating a concept of an operation of a system for operating customized recommended information according to various embodiments of the present disclosure;

FIG. 3 is a diagram illustrating a concept for describing a fitness evaluation according to various embodiments of the present disclosure;

FIG. 4 is a flowchart illustrating a method of operating a customized proposal service according to various embodiments of the present disclosure;

FIG. 5 is a flowchart illustrating a method of operating a customized proposal service according to various embodiments of the present disclosure;

FIG. 6 is a flowchart illustrating a method of operating a customized proposal service according to various embodiments of the present disclosure; and

FIG. 7 is a flowchart illustrating a method of operating a customized recommended information service according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The apparatus for operating the customized proposal service and the electronic device may be electronic devices including a communication function. For example, the electronic device may be one or a combination of a smart phone, a tablet personal computer (PC), a mobile phone, a video phone, an e-book reader, a desktop PC, a laptop PC, a netbook computer, a personal digital assistant (PDA), a camera, a wearable device (for example, a head mounted device (HMD) such as electronic glasses, electronic clothes, and electronic bracelet, an electronic necklace, an electronic accessory, an electronic tattoo, and a smart watch.

According to various embodiments of the present disclosure, the electronic device may be a smart home appliance having a projection function. The smart home appliance may include at least one of a television (TV), a digital versatile disc (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame.

According to various embodiments of the present disclosure, the electronic device may include at least one of various types of medical devices (for example, magnetic resonance angiography (MRA), magnetic resonance imaging (MRI), computed tomography (CT), a scanner, an ultrasonic device and the like), a navigation device, a global positioning system (GPS) receiver, an event data recorder (EDR), a flight data recorder (FDR), a vehicle infotainment device, electronic equipment for a ship (for example, a navigation device for ship, a gyro compass and the like), avionics, a security device, a head unit for a vehicle, an industrial or home robot, an automatic teller machine (ATM) of financial institutions, and a point of sale (POS) device of shops.

According to various embodiments of the present disclosure, the electronic device may include at least one of various types of medical devices (for example, MRA, MRI, CT, a scanner, an ultrasonic device and the like), a navigation device, a GPS receiver, an EDR, a FDR, a vehicle infotainment device, electronic equipment for a ship (for example, a navigation device for ship, a gyro compass and the like), avionics, a security device, a head unit for a vehicle, an industrial or home robot, an ATM of financial institutions, and a POS device of shops.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) which uses an electronic device.

In the present disclosure, “recommended information” may be recommended information, which suggests information related or similar to a use pattern of a client generated by analyzing the use pattern of the client according to a proposal service field. The recommended information may include information suggesting contents, an item, an application, a product, and the like, and may include smart home control information (for example, operation control information of a smart TV, an air conditioner, a washing machine, and a vacuum cleaner) according to a living pattern of a client. For example, when a client repeatedly reproduces specific classical music, the recommended information may be information suggesting other classical music that is generated by analyzing the music pattern of the client.

In the present disclosure, “a proposal generating algorithm” may be a gene algorithm, which first configures a population with candidate entities in a specific field, reproduces the candidate entities within the population in a combination of a binary number, and generates proposal entities (for example, individual or chromosome). Then, the proposal generating algorithm generates new proposal entities by crossing or mutating the generated proposal entities, selecting fitness of the generated entities and selecting the entities as a population to be transferred to a next generation, and configuring the population in the next generation, and repeating the processes from the reproduction to the selection.

In the present disclosure, the “recommended information” may be information generated by changing the “proposal entity” generated through the proposal generating algorithm into an expression form to be provided to a client device. For example, the proposal entity may have a form (for example, 0001) expressed by a binary number, and the recommended information may have a form (for example, classical in a music field, Korean food in a food field, and an output channel in a television field) expressed as a user interface (UI) or command information.

The proposal service apparatus according to various embodiments of the present disclosure may be an electronic device (for example, a server), which stores common information in a communication network connecting a plurality of electronic devices through communication lines, or in which programs using a lot of resources of an electronic device, such as a memory, are executed, but is not limited thereto.

A client may search for necessary information and receive the searched information from the proposal service apparatus, or transmit data to be processed by the proposal service apparatus and receive a result of the process from the proposal service apparatus. For example, the proposal service apparatus may be a server device providing information to a client through the Internet, and a client may be an electronic device of a user, which desires to search for information by accessing a server device, but the proposal service apparatus and the client are not essentially limited thereto.

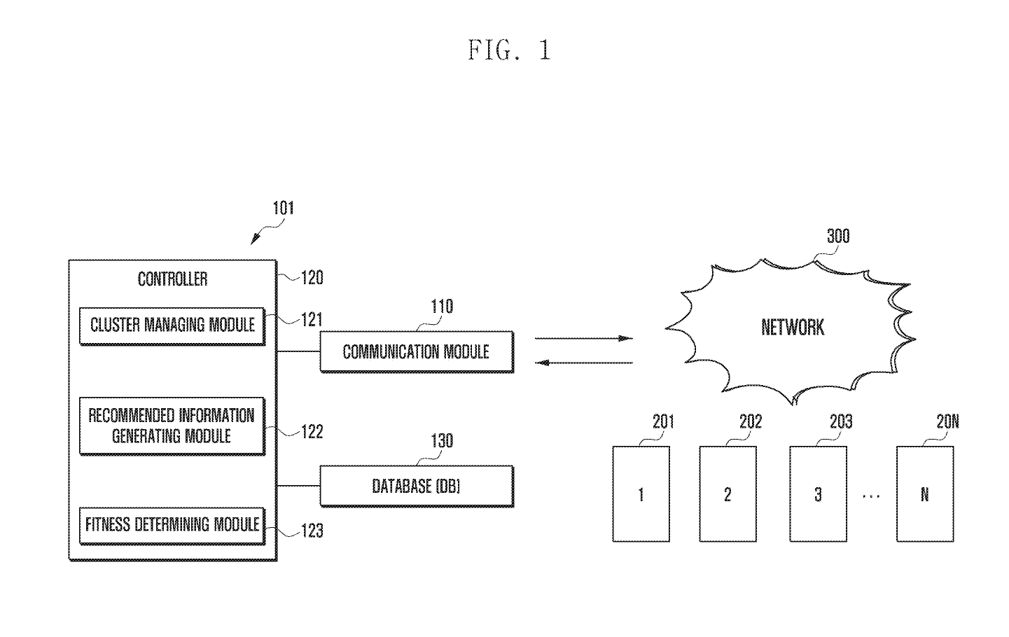

FIG. 1 is a diagram illustrating a configuration of a system for operating a customized recommended information service according to various embodiments of the present disclosure.

Referring to FIG. 1, the system for operating a customized recommended information service according to various embodiments may include a proposal service apparatus 101, which analyzes a pattern of a user and provides recommended information to a client, and a plurality of clients 201, 202, 203, . . . , and 20N corresponding to users, respectively.

A network 300 may establish communication channels between the proposal service apparatus 101 and the clients 201, 202, 203, . . . , and 20N. The network 300 may be a telecommunication network. The communication network is not limited to communication networks with known various schemes, such as a computer network, the Internet, Internet of Things or a telephone network, a wireless local area network (LAN) including a Wi-Fi network, a mobile communication network, and a satellite communication network, but may be a next-generation communication network that is expected to be developed.

The proposal service apparatus 101 may analyze use patterns of the clients 201, 202, 203, . . . , and 20N and generate recommended information in accordance with the clients 201, 202, 203, . . . , and 20N according to a proposal service field, and provide the generated recommended information to the clients 201, 202, 203, . . . , and 20N.

The proposal service apparatus 101 may include a communication module 110 communicating with the clients 201, 202, 203, . . . , and 20N, a controller 120 managing and analyzing data for supporting a customized proposal service, and a database (DB) 130.

The communication module 110 may transceive data with the clients 201, 202, 203, . . . , and 20N connected with the proposal service apparatus 101 through the network. The communication module 110 may include a cellular module, a Wi-Fi module, a Bluetooth (BT) module, a GPS module, a near field communication (NFC) module, and a radio frequency (RF) module.

The controller 120 may further include a cluster managing module 121, a recommended information generating module 122, a fitness determining module 123, and a DB managing module 124.

The cluster managing module 121 may control so that the clients 201, 202, 203, . . . , and 20N communicating with the proposal service apparatus 101 are clustered based on a similar tendency according to a predetermined reference and are managed. For example, the cluster managing module 121 may cluster the clients through an association rule, collaborative filtering, and the like. The association rule may include a female rule, a male rule, an age rule, a residence rule, and the like. The collaborative filtering may be a method for identifying clients having a similar pattern in preference and interests based on preference and information of interest of the clients.

The recommended information generating module 122 may analyze data based on the use patterns of the clients 201, 202, 203, . . . , and 20N and generate recommended information for the proposal service field.

In one embodiment of the present disclosure, the recommended information generating module 122 may configure a population with candidate entities corresponding to a proposal service field through the proposal generating algorithm, and generate a proposal entity by reproducing the candidate entities of the population into a combination of binary number. For example, when the proposal service field is “music”, the recommended information generating module 122 may generate recommended information in a music field by reproducing candidate entities for the music, and the recommended information may be represented in Table 1 below. The recommended information in Table 1 may be proposal entities expressed by duodecimality, but the proposal entity may be generated by another expression (for example, hexadecimality or an octal number) according to a characteristic of the recommended information.

TABLE 1

| Candidate | | | |
|---|---|---|---|
| entity 1 | Candidate entity 2 | Candidate entity 3 | Proposed entity |
| (Large | (Medium | (Small | (Recommended |
| classification) | classification) | classification) | information) |
| 0001 | 0000 Symphony | 0000 Beethoven | 0001 0000 0000 |
| (Classical) | 0001 Variation | 0001 Mozart | (Classical - Symphony - |
| | 0010 Concerto | 0010 Hayden | Beethoven) |
| | (Violin) | 0011 Elgar | 0001 0001 0001 |
| | 0011 Concerto | 0100 Handel | (Classical - Variation - |
| | (Cello) | 0101 Vivaldi | Mozart) |
| | 0100 Concerto | 0110 . . . | 0001 0011 0010 |
| | (Piano) | 0111 . . . | (Classical - Concerto |
| | 0101 Concerto | 1000 . . . | (Cello) - Hayden) |
| | (Flute) | 1001 . . . | 0001 0011 0011 |
| | 0110 Concerto | 1010 . . . | (Classical - Concerto |
| | (Clarinet) | 1011 . . . | (Cello) - Elgar) . . . |
| | 0111 Sonata | 1100 . . . | 0001 0110 0001 |
| | 1000 Ballad | | (Classical - Concerto |
| | 1001 Nocturne | | (Clarinet) - Mozart) |
| | 1010 Chamber | | 0001 1010 0101 |
| | music | | (Classical - Chamber |
| | 1011 . . . | | music - Vivaldi) |
| | 1100 . . . | | |
| . . . 0010 | 0000 Authentic | 0000 70's | 0010 0000 0000 |
| (Rock) | metal | 0001 80's | (Rock - Authentic metal - |
| | 0001 L.A metal | 0010 90's | 70's) |
| | 0010 Pop metal | 0011 2000's | 0010 0000 0010 |
| | 0011 Slash metal | 0100 . . . | (Rock - Authentic metal - |
| | 0100 . . . | | 90's) |
| | | | 0010 0001 0010 |
| | | | (Rock - Pop metal - 90's) . . . |
| 0011 | 0000 Ballad | 0000 Girls' | 0011 0000 0011 |
| (Popular | 0001 Dance | Generation | (Popular song - Ballad - |
| song) | 0010 Idol | 0001 Miss A | SHIN Seung-Hun) |
| | 0011 Girl-group | 0010 Wonder Girls | 0011 0011 0000 |
| | 0100 . . . | 0011 SHIN, Seung- | (Popular song - Girl-group- |
| | | Hun | Girls' Generation) |
| | | 0100 . . . | 0011 0011 0001 |
| | | | (Popular song - Girl-group- |
| | | | Miss A) |
| | | | 0011 0011 0010 |
| | | | (Popular song - Girl-group- |
| | | | Wonder Girls) . . . |

As represented in Table 1, the recommended information generating module 122 may generate the proposal entities in relation to the music. The recommended information generating module 122 may modify the generated proposal entity through crossover and mutation and generate the modified proposal entity. Further, the recommended information generating module 122 may randomly select the generated proposal entity and provide the client device with the selected proposal entity as recommended information, and modify the proposal entity by reflecting feedback information obtained from the clients 201, 202, 203, . . . , and 20N and generate the modified proposal entity. The proposal entity may be a set of values generable through the candidate entities.

In order to provide the client device with the generated proposal entity, the recommended information generating module 122 may change the generated proposal entity into an expression form and provide the client device with the changed proposal entity.

The recommended information generating module 122 may transfer the generated recommended information to the fitness determining module 123.

The fitness determining module 123 may evaluate the fitness for the generated recommended information and select the evaluated recommended information as a population to be transferred to a next generation. In one example, the fitness determining module 123 may evaluate whether the recommended information is fitted as a value of a specific issue (for example, whether the recommended information is a proposal optimized to a characteristic and tendency of a specific client) by applying a fitness function. For example, the fitness determining module 123 may evaluate fitness of the recommended information by converting feedback information obtained from the clients 201, 202, 203, . . . , and 20N as numerical values, and converting the converted numeral values into fitness scores.

The fitness determining module 123 may select the customized recommended information optimized to a specific client by repeatedly performing a process of evaluating the fitness of the recommended information and identifying the recommended information, which is to be transmitted to a next generation or is to be excluded.

For example, when the fitness score of the recommended information meets a predetermined reference value, the fitness determining module 123 may select the recommended information as a population for generating recommended information of a next generation, and when the fitness score of the recommended information does not meet the predetermined reference value, the fitness determining module 123 may exclude the recommended information from a population of a next generation. For example, the fitness determining module 123 may assign ranking to the recommended information based on the fitness score, select recommended information by a predetermined probability according to the ranking, and select the recommended information as a population for generating recommended information of a next generation.

The DB 130 may store various data required for operating the proposal service under the control of the controller 120. The DB 130 may store data for the client (for example, gender, age, job, and residence of the user), and use pattern data related to the client (for example, contents or product purchase information, contents or application use information, control information within an electronic device, location information, a social network service use history, a call history, an NFC control history, and a BT use history).

The DB 130 may cluster and store the data for the clients. For example, the controller 120 may control so that the clients, based on a use pattern for a contents purchase history, product purchase history, gender, age, residence, job, and the like of the respective client device, are clustered into a similar tendency, and data are classified and managed.

The clients 201, 202, 203, . . . , and 20N may be the electronic devices of the user, which is connected with the proposal service apparatus 101 through the network 300 and may receive the recommended information. The clients 201, 202, 203, . . . , and 20N may support a communication function with the proposal service apparatus 101, an operation control function based on the recommended information, a recommended information display function, an input function, a feedback information transfer function corresponding to the recommended information, a signal or data transceiving function, and the like. For example, the clients 201, 202, 203, . . . , and 20N may support an operation of receiving the recommended information from the proposal service apparatus 101, an operation of operating an electronic device based on the recommended information, an operation of receiving feedback information related to the recommended information from the user, and an operation of transmitting the received feedback information to the proposal service apparatus 101.

Although not illustrated in the drawing in detail, the clients 201, 202, 203, . . . , and 20N may include a communication unit for communicating with the proposal service apparatus 101, an input unit for providing information about the recommended information service to the user, an input unit for feedback information about the recommended information or operating a device, and a controller for controlling a device operation.

The clients 201, 202, 203, . . . , and 20N may provide the user with the recommended information received from the proposal service apparatus 101. The clients 201, 202, 203, . . . , and 20N may request the user to evaluate the recommended information for determining the provided recommended information, and receive feedback information from the user. For example, the clients 201, 202, 203, . . . , and 20N may display evaluation request screens on display units (not illustrated) for determining the recommended information, receive an input for the evaluation from the user, and transmit the received input to the proposal service apparatus 101.

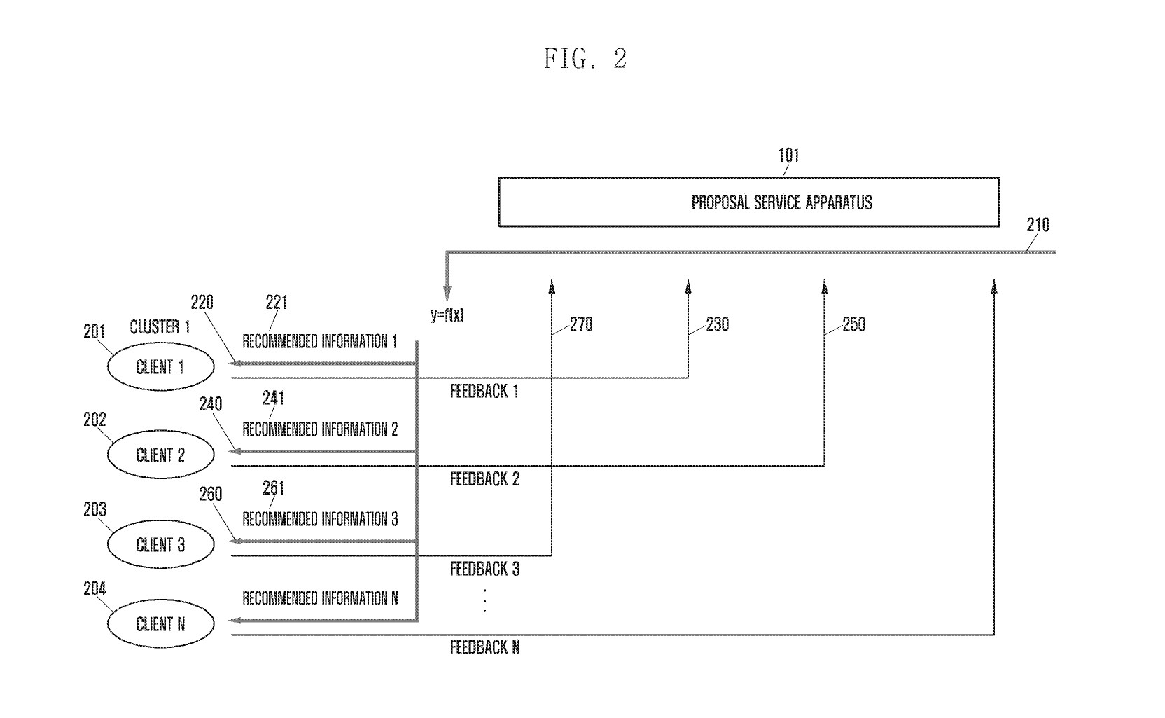

FIG. 2 is a diagram illustrating a concept of an operation of a system for operating customized recommended information according to various embodiments of the present disclosure.

Referring to FIG. 2, cluster 1 classified through grouping may include a plurality of clients (for example, client 1 201, client 2 202, client 3 203, . . . , and client N 204) exhibiting a similar tendency.

In operation 210, the proposal service apparatus 101, according to the embodiment of the present disclosure, generates recommended information based on a tendency and a pattern of the cluster in order to provide the clients included in the cluster 1 with a proposal service. The recommended information may correspond to a proposal entity expressed by a binary number through the proposal generating algorithm. The proposal service apparatus 101 may change the generated proposal entity into an expression form to be provided to the client and provide the client device with the changed proposal entity as the recommended information.

In operation 220, the proposal service apparatus 101 provides the client 1 201 included in the cluster 1 with one predetermined proposal entity among the generated proposal entities as recommended information 1 221. For example, in a music recommendation service field, when the client 1 201 has a classical tendency based on the pattern thereof, the proposal service apparatus 101 may provide “Classical—Concerto (Cello)—Hayden” as the recommended information 1 221 in response to the proposal entity “0001 0011 0010” mentioned in Table 1.

The client 1 201 may reproduce “Classical—Concerto (Cello)—Hayden” or notify the user of information about “Classical—Concerto (Cello)—Hayden”.

The client 1 201 may request feedback information about the recommended information 1 221 from the user, or receive feedback information (for example, feedback 1) from the user. For example, the client 1 201 may output a plurality of evaluation grades (for example, very satisfied, satisfied, normal, bad, and very bad) for “Classical—Concerto (Cello)—Hayden” on a screen, and receive a selection for the evaluation grade of “normal” from the user. Otherwise, when the user of the client 1 201 does not listen to “Classical—Concerto (Cello)—Hayden” and reproduces another music, the client 1 201 may obtain information about another music as feedback information.

In operation 230, the client 1 201 transfers the feedback information 1 of the user for the recommended information 1 221 to the proposal service apparatus 101.

Then, the proposal service apparatus 101 may modify (cross the proposal entity with another entity) the recommended information 1 221 based on the feedback information 1 obtained from the client 1 201 and generate a modified proposal entity.

Here, the modified proposal entity may be modified into an X′ type, to which the feedback information is reflected, an X-1 type, which is generated by crossing the proposal entity with another proposal entity of a corresponding generation, and a mutation XY type generated by considerably changing the proposal entity. For example, when the user of the client changes the music to “Rock version—Concerto (Cello)—Hayden”, the X′ type may be “0010 0011 0010” generated by reflecting “Rock version—Concerto (Cello)—Hayden”. The X-1 type may correspond to “Classical concerto (Clarinet) Mozart” corresponding to “0001 0110 0001”. The XY type may be “Popular music—Girl group—Girls' Generation” corresponding to “0011 0011 0000”.

In operation 240, the proposal service apparatus 101 provides the client 2 202, other than the client 1 201, with recommended information 2 241. The recommended information 2 241 may be the modified proposal entity (for example, “0001 0110 0001”) generated by crossing with another proposal entity different from the proposal entity “0001 0011 0010”, and “Classical concerto (Clarinet) Mozart” corresponding to “0001 0110 0001” may be provided to the client 2 202 as the recommended information 2 241.

The client 2 202 may request feedback information about the recommended information 1 221 from the user, or receive feedback information (for example, feedback 2) from the user. For example, a user of the client 2 202 may evaluate “Classical concerto (Clarinet) Mozart” with the evaluation grade of “Satisfied”.

In operation 250, the client 2 202 transfers feedback information 2 of the user for the recommended information 2 241 to the proposal service apparatus 101. Then, the proposal service apparatus 101 may generate a proposal entity generated by modifying the recommended information 1 221 or the recommended information 2 241 based on the feedback information 2 obtained from the client 2 202.

In operation 260, the proposal service apparatus 101 provides the client 3 203 with recommended information 3 261. The recommended information 3 261 may be a mutation proposal entity different from “0001 0011 0010” and “0001 0110 0001”, and may be “Popular music—Girl group—Girls' Generation” corresponding to “0011 0011 0000”. The client 3 203 included in the classical cluster may evaluate the recommended information for “Popular music—Girl group—Girls' Generation” with the evaluation grade of “Very satisfied”.

In operation 270, the client 3 203 transfers feedback information 3 of the user for the recommended information 3 261 to the proposal service apparatus 101. Then, the proposal service apparatus 101 may search for recommended information having high fitness while repeating a process of generating another proposal entity by reflecting or modifying the feedback information 3 for the recommended information 3 261, providing the generated proposal entity to another client N 204 included in the cluster 1, and receiving feedback.

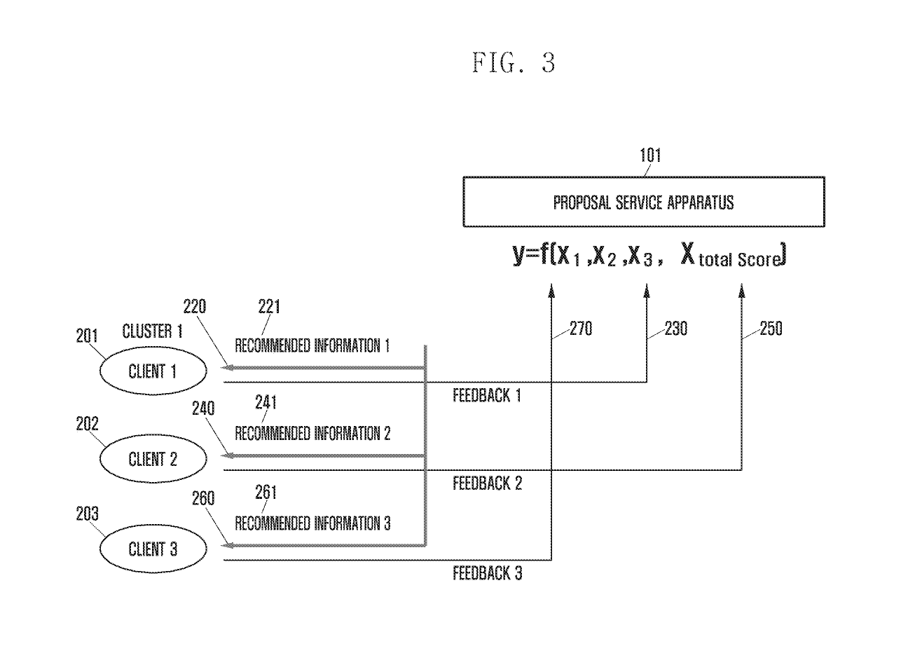

FIG. 3 is a diagram illustrating a concept for describing a fitness evaluation according to various embodiments of the present disclosure.

Referring to FIG. 3, the proposal service apparatus 101 according to various embodiments of the present disclosure may evaluate fitness of a proposal entity by applying a fitness function to a proposal entity corresponding to recommended information and reflecting feedback information about the recommended information.

In one example, the fitness function for evaluating the fitness may be expressed by Equation 1 below.

y=f(X₁,X₂,X₃,X_{totalscore}) Equation 1

Here, X₁ may mean a feedback value received at the first time, X₂ may mean a feedback value received at the second time, and X3 may mean a feedback value received at the third time. The fitness evaluation may evaluate fitness of a proposal entity by combining the feedback values received from the clients and converting the combined feedback value into a satisfaction score.

The proposal service apparatus 101 may generate a proposal entity for each proposal service field. The proposal service apparatus 101 may provide the client with proposal entities in different fields as the recommended information. For example, the proposal service apparatus 101 may generate the proposal entities for each proposal service field represented in Table 2 below through the proposal generating algorithm.

TABLE 2

| | Y1(Musie) | Y2(Light) | Y3(TV) | Satisfaction |
|---|---|---|---|---|
| Recommended | 0001 1011 0010 | 0011 1011 0110 | 1101 0011 1010 | 5 |
| information 1 | | | | |
| Recommended | 0001 0110 0001 | 0011 0000 1000 | 0101 0111 1110 | 4 |
| information 2 | | | | |
| Recommended | 0011 0011 0000 | 0100 1111 0010 | 0010 1110 0010 | 3 |
| information 3 | | | | |

The proposal service apparatus 101 may change “0001 1011 0010” in the music field, “0011 1011 0110” in the light field, and “1101 0011 1010” in the TV field into an expression form, and provide the client 1 201 with the recommended information 1 221.

The fitness function of the recommended information for the proposal entities in the different fields may be represented as Table 3 below.

TABLE 3

{ y _{similarity} = f _{similarity}(Client n) // similarity test
if ( y _{similarity} ≦ threshold value)
{ y1 = f₁(x₁) // attribute 1 (music) proposal
y2 = f₂(x₂) // attribute 2 (light) proposal
y3 = f₃(x₃) // attribute 3 (TV) proposal
}
insert (y₁, y₂, y₃, X _{total Score})

The client 1 201 may evaluate the recommended information 1 221 with the evaluation grade, and transfer the feedback information to the proposal service apparatus 101. For example, when the client 1 201 evaluates the recommended information 1 221 as “Very satisfied”, the proposal service apparatus 101 may convert “Very satisfied, Satisfied, Normal, Bad, Very bad” into scores (for example, 5 to 1) and convert the satisfaction of the recommended information 1 into “5”. When the first evaluation score of the recommended information 1 221 is “5” and the proposal service apparatus 101 provides another client with the recommended information 1 221, and receives an evaluation score for the recommended information 1 221 at the second time, the proposal service apparatus 101 may evaluate the recommended information 1 221 by receiving an evaluation score among “Very satisfied, Satisfied, Normal, Bad, Very bad” and accumulating the satisfaction scores (the evaluation score is changed to 8 by accumulating the first evaluation score 5 and the new evaluation score 3 (Normal)). The proposal service apparatus 101 may select the proposal having the highest score as an optimal proposal entity by evaluating fitness by repeating the process of accumulating the satisfaction scores by reflecting the feedback information.

According to various embodiments of the present disclosure, the proposal service apparatus 101 may generate the recommended information 2 241 of Table 2 modified to have a lower evaluation score (for example, satisfaction is changed from 5 to 4) than the evaluation score of the recommended information 1 221 and suggest the recommended information 2 241 to the client 2 202, or generate the recommended information 3 261 of Table 2 and suggest the generated recommended information 3 261 to the client 3 203. The proposal service apparatus 101 may evaluate fitness by converting feedback information about the recommended information 2 241 or the recommended information 3 261 into a satisfaction score, and select optimal recommended information.

Particularly, the recommended information 2 241 may be modified recommended information (for example, the X′-type) generated by reflecting the feedback information of the client 1 201, and the recommended information 3 261 may be modified recommended information (for example, the X-1 type) generated by the mutation rule.

When the client 2 202 satisfies the recommended information 2 241, the proposal service apparatus 101 may maintain a setting value for the recommended information 2 241, and the recommended information 2 241 may be evaluated to have a high score through the fitness function. The proposal service apparatus 101 may suggest the recommended information 3 261 generated by the mutation rule to the client 3 203. When the client 3 203 does not satisfy the recommended information 3 261 and changes the recommended information 3 261 and provides the feedback information, the recommended information 3 261 may be evaluated to have a low score through the fitness function.

The proposal service apparatus 101 may obtain the feedback information about the recommended information 2 241 having a high score from another client, and a fitness score of the recommended information 2 241 may be increased and the recommended information 2 241 may be selected as a population to be transferred to a next generation. However, the proposal service apparatus 101 may obtain the feedback information about the recommended information 3 261 having a low score from another client, so that a fitness score of the recommended information 3 261 may be decreased and the recommended information 3 261 may be excluded from a population to be transferred to a next generation.

In the meantime, for the recommended information corresponding to the mutation type (for example, the XY type, “Popular music—Girl group—Girls' Generation” corresponding to “0011 0011 0000” of FIG. 2), the recommended information deviating from a similar tendency pattern of a cluster may also be generated, and in this case, a high score may be obtained from the client. The user may find serendipity (unexpected good recommended information) deviating from an existing used pattern and feel interest. The fitness score of the recommended information corresponding to the mutation type may be increased and selected as the population to be transferred to the next generation, and the proposal service apparatus 101 may generate unexpected good recommended information.

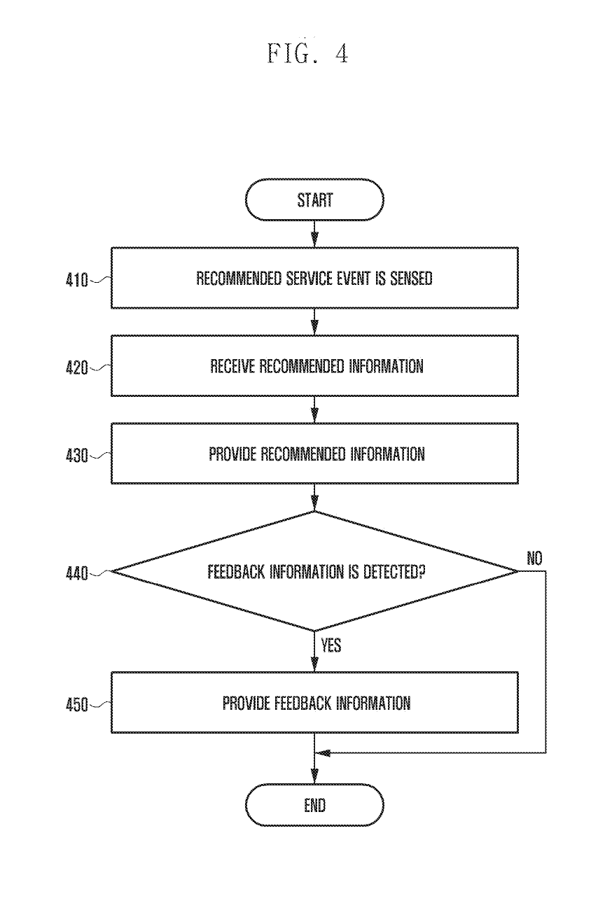

FIG. 4 is a flowchart illustrating a method of operating a customized proposal service according to various embodiments of the present disclosure.

Referring to FIG. 4, in various embodiments of the present disclosure, in operation 410, the client senses an event instructing an operation of a recommended service. For example, the client executes a music application or accesses a game contents download server, the client may sense the generation of a recommended service event. Otherwise, when the client supports a smart home service and confirms that a user of the client enters a home based on location information, the client may sense the generation of a recommended service event. Here, the smart home service means a service controlling a light, a temperature, a background music (BGM), a TV, a security system, and the like to be automatically set and operated by reflecting a taste of the user according to whether the user is present at an indoor side providing smart home.

In operation 420, the client receives recommended information by sensing the generation of the recommended service event, and in operation 430, the client provides the user with the recommended information. For example, when the recommended information is recommended information in a music field, the client may reproduce recommended music or notify the user of the existence of the recommended music.

For example, when the client supports the recommended information service for a smart home environment and the user arrives at home at a closing time, the client may control a music reproduction device to reproduce the music of Vivaldi's Four Seasons, Second movement, with volume 8 (a high-pitched tone 7, a medium-pitched tone 5, and a low-pitched tone 6), control a living room light to 4, a kitchen light to 5, and a room light 0, turn a TV to show a news channel, and control volume of the TV to 1, based on the recommended information received through the proposal service apparatus. Further, the client 1 may control a heating device to be operated at a temperature of 28° C. and a coffee machine to be heated to 60° C., and control a mobile phone to block contacts from other users, other than an emergency contact.

In operation 440, the client determines whether feedback information of the user for the recommended information is detected.

For example, in the smart home environment, the user may turn down the music reproduction volume to two levels, change a channel of the TV to a documentary channel, and adjust a living room light from 4 to 7 in the smart home environment. The client may confirm adjustment control information of the user, and detect the confirmed adjustment control information as the feedback information.

As another example, when the proposal service apparatus requests an evaluation (for example, the evaluation grade of Very satisfied, Satisfied, Normal, Bad, and Very bad) of the recommended information from the client, the client may provide the user with information requesting the evaluation of the recommended information, confirm the evaluation grade according to the user input, and detect the confirmed evaluation grade as the feedback information.

In operation 450, when the feedback information of the user is detected, the client transfers the feedback information of the user to the proposal service apparatus. When the feedback information of the user is not detected, the client terminates the process.

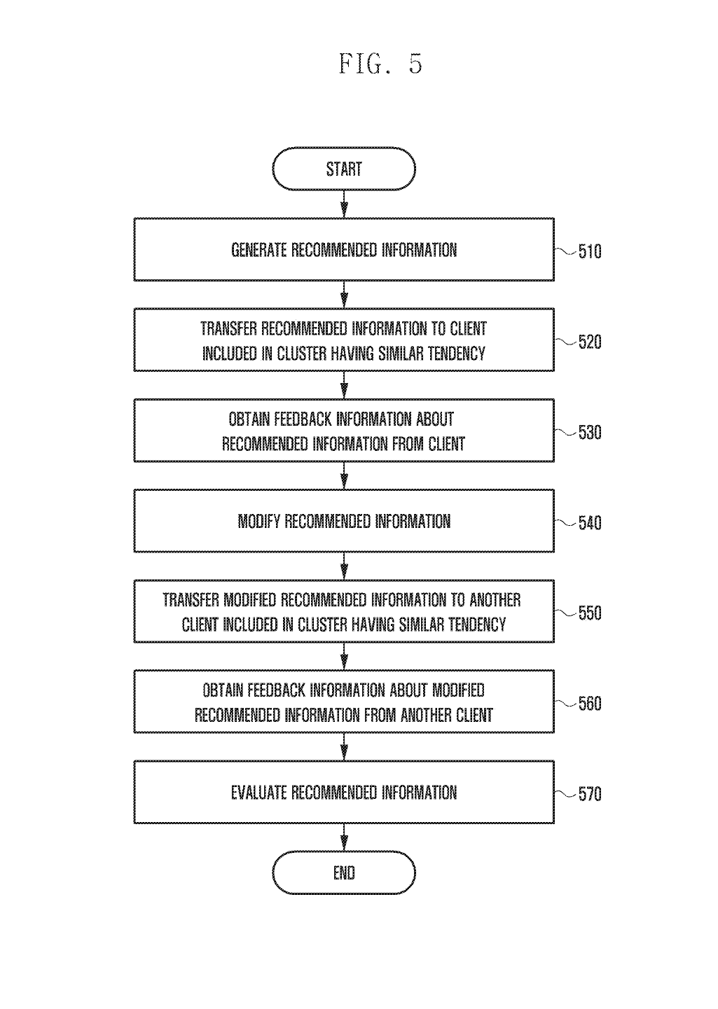

FIG. 5 is a flowchart illustrating a method of operating a customized proposal service according to various embodiments of the present disclosure.

Referring to FIG. 5, in operation 510, the controller (for example, the controller 120 of the proposal service apparatus of FIG. 1) analyzes a use pattern of one cluster classified as a similar tendency and generates recommended information. Here, the recommended information may correspond to a proposal entity generated by using the proposal generating algorithm of FIG. 2.

In operation 520, the controller transfers the generated recommended information to the client included in one cluster having a similar tendency. The client may control the electronic device by using the recommended information received from the proposal service apparatus or notify the user of the recommended information.

In operation 530, the controller obtains feedback information about the recommended information from the client receiving the recommended information. The feedback information may contain information on an evaluation grade, control information of the client device, and the like.

In operation 540, the controller modifies the recommended information, of which the feedback information is obtained, and generates modified recommended information. For example, the controller may generate the modified recommended information by crossing the proposal entity corresponding to the recommended information or modifying the proposal entity into a mutation by using the proposal generating algorithm. For another example, the controller may generate the modified recommended information by reflecting the feedback information obtained from the client. For example, the modified recommended information may be modified into the X′ type, to which the feedback information is reflected, the X-1 type, which is generated by crossing the recommended information with another recommended information of a corresponding generation, and a mutation XY type generated by considerably changing the recommended information.

The controller may recommend (for example, transfer) the modified recommended information to another client, which does not provide the feedback information about the recommended information within the cluster having the similar tendency, in which the specific client is included, and a client included in another cluster having a similar tendency.

In operation 550, the controller transfers the modified recommended information to another client included in the cluster having the similar tendency. In operation 560, the controller obtains feedback information about the modified recommended information from another client, and in operation 570, the controller evaluates the recommended information and the modified recommended information. The controller may evaluate the recommended information and the modified recommended information through the fitness function described with reference to FIG. 3.

After the controller evaluates the recommended information and the modified recommended information, the controller may update a DB storing use pattern information, and may select recommended information more optimized to the user by repeating operations 540 to 570.

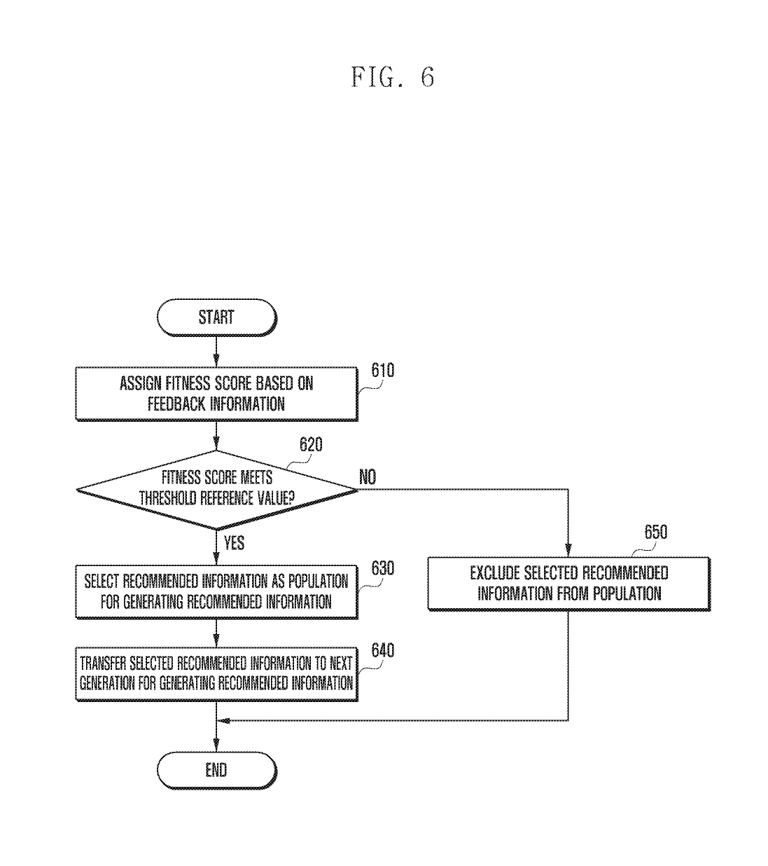

Hereinafter, a method of selecting the recommend information based on the proposal generating algorithm will be described with reference to FIG. 6.

FIG. 6 is a flowchart illustrating a method of operating a customized proposal service according to various embodiments of the present disclosure.

Referring to FIG. 6, in operation 610, the controller of the proposal service apparatus assigns a fitness score to the recommended information provided to the client based on the feedback information. A satisfaction score may be calculated by applying the fitness function described with reference to FIG. 3 to the fitness score.

In operation 620, the controller determines whether the fitness score of the recommended information meets a threshold reference value. In operation 630, the controller selects the recommended information meeting the threshold reference value.

In one example, the controller may calculate the fitness score for the recommended information, assigns a ranking to the recommended information based on the fitness score, and probabilistically (for example, top 40% or top 50%) select the recommended information as a population for generating next recommended information in an order of a higher fitness score.

For example, the controller may set a threshold reference value for the fitness score, and select the recommended information, which is evaluated to have a higher score than the set reference value, as a population for generating next recommended information.

In operation 640, the controller transfers the selected recommended information to the population for generating the recommended information of a next generation, and in operation 650, the controller excludes the recommended information, of which the fitness score does not meet the threshold reference value, or which is evaluated to have a lower score than the set reference value, from a population for generating next recommended information.

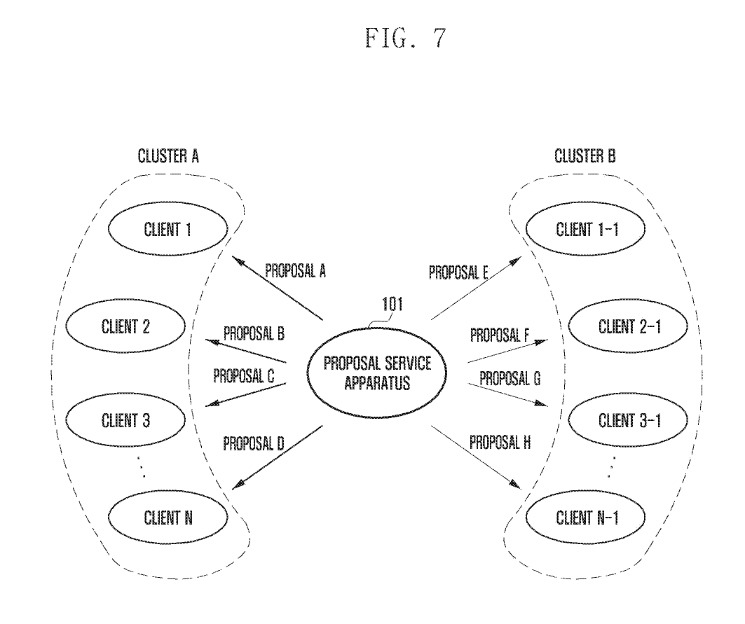

FIG. 7 is a flowchart illustrating a method of operating a customized recommended information service according to various embodiments of the present disclosure.

Referring to FIG. 7, according to the embodiment of the present disclosure, the proposal service apparatus may adjust a scheduling so as to process operations of providing a client with recommended information and obtaining feedback information in parallel.

For example, the clients stored in the DB may be classified into cluster A and cluster B. Each of the cluster A and the cluster B may include client 1, client 2, client 3, . . . , and client N by clustering the clients based on a similar tendency.

In another embodiment of the present disclosure, the proposal service apparatus may control an operation of generating recommended information (for example, proposal A, proposal B, proposal C, and proposal D) based on use pattern information stored for each client included in the cluster A to be processed in parallel. For example, the proposal service apparatus may simultaneously perform an operation of providing the client 1 with the recommended information, an operation of providing the client 2 with the recommended information, an operation of providing the client 3 with the recommended information, and an operation of providing the client 4 with the recommended information in parallel.

Otherwise, the proposal service apparatus may control the operation of providing the recommended information to be processed in parallel for each cluster A and cluster B without limiting to one cluster. The proposal service apparatus may simultaneously perform the operation of providing the cluster A with proposal A, proposal B, proposal C, and proposal D and the operation of providing the cluster B with proposal E, proposal F, proposal G, and proposal H in parallel.

As illustrated in FIG. 7, the proposal service apparatus may support the recommended information service to be provided by performing an operation of calculating an optimum value for each client exhibiting several similar tendencies in parallel by adjusting a scheduling of an algorithm for obtaining an optimum value.

According to various embodiments of the present disclosure, at least some of the devices (for example, modules or functions thereof) or the method (for example, operations) according to the present disclosure may be implemented by a command stored in a non-transitory computer-readable storage medium in a programming module form. When the instructions are executed by at least one processor (e.g., controller 120), the at least one processor may perform functions corresponding to the instructions. The computer-readable storage medium may be, for example, the database 130. At least a part of the programming module may be implemented (for example, executed) by, for example, the at least one processor. At least some of the programming modules may include, for example, a module, a program, a routine, a set of instructions, or a process for performing one or more functions.

The computer-readable recording medium may include magnetic media such as a hard disk, a floppy disk, and a magnetic tape, optical media such as a compact disc read only memory (CD-ROM) and a digital versatile disc (DVD), magneto-optical media such as a floptical disk, and hardware devices specially configured to store and perform a program instruction (for example, programming module), such as a ROM, a RAM, a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The module or programming module of the present disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations

According to various embodiments of the present disclosure, in a storage medium storing commands, the commands are set to enable one or more processors to perform one or more operations when being executed by one or more processors, and the one or more operations may include an operation of, by the proposal service operating apparatus, transferring recommended information generated based on use pattern information of a client communicating with the proposal service operating apparatus to one or more clients, an operation of receiving feedback information about the recommended information from the client, to which the recommended information is transferred, an operation of generating modified recommended information derived from the recommended information, an operation of transferring the generated modified recommended information to a client different from the client, which provides the feedback information about the recommended information, and an operation of receiving feedback information about the modified recommended information from the different client.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus for operating a customized proposal service, the apparatus comprising:
a database (DB) configured to store use pattern information about one or more client devices;
a communication module configured to communicate with the one or more client devices; and
a processor configured to:
provide recommended information for a proposal service field based on a use pattern of a first client device,
provide a second client device with modified recommended information by reflecting feedback information when the feedback information about the provided recommended information is received from the first client device, and
receive feedback information about the modified recommended information from the second client device and evaluate the recommended information and the modified recommended information.

2. The apparatus of claim 1, wherein the processor is further configured to update the DB by repeatedly performing the generation of the modified recommended information, the provision of the modified recommended information, the reception of the feedback information, and the evaluation of the recommended information and the modified recommended information.

3. The apparatus of claim 1, wherein the processor is further configured to:
control to cluster the client devices stored in the DB for each cluster having a similar tendency according to the use pattern information,
generate the recommended information and the modified recommended information for each pattern of the cluster having the similar tendency, and
receive the feedback information from the client devices included in the cluster having the similar tendency.

4. The apparatus of claim 1, wherein the processor is further configured to:
configure a population with candidate entities included in a specific service field, and
generate the recommended information and the modified recommended information by reproducing the candidate entities into a combination of a binary number and generating proposal entities, generating modified proposal entities by crossing or mutating the proposal entities, or generating modified proposal entities by reflecting the feedback information.

5. The apparatus of claim 4, wherein the processor is further configured to:
calculate a fitness score of the recommended information and the modified recommended information based on the feedback information, and
select the recommended information according to the fitness score.

6. The apparatus of claim 5,
wherein, when the fitness score of the recommended information or the modified recommended information meets a predetermined reference value, the processor is further configured to select the recommended information as a candidate for generating next recommended information, and
wherein, when the fitness score of the recommended information or the modified recommended information does not meet the predetermined reference value, the processor is further configured to exclude the recommended information from a candidate for generating next recommended information.

7. The apparatus of claim 3, wherein the processor is further configured to control an operation of providing the modified recommended information to another client device within the cluster having the similar tendency to be processed in parallel.

8. The apparatus of claim 7, wherein, in the case of the parallel processing, the processor is further configured to:
control the operation to be processed in parallel for each client device included in the cluster having the similar tendency, or
control the operation to be processed in parallel for each grouped cluster having the similar tendency.

9. A method of operating a customized proposal service, the method comprising:
transferring recommended information, which is generated for a proposal service field based on use pattern information of clients communicating with a proposal service operating apparatus, to one or more clients;
receiving feedback information for the recommended information from a first client among the one or more clients, to which the recommended information is transferred;
generating modified recommended information by reflecting the feedback information;
transferring the generated modified recommended information to a second client among the one or more clients; and
receiving feedback information for the modified recommended information from the second client.

10. The method of claim 9, further comprising:
repeatedly performing the generating of the modified recommended information, the transferring of the modified recommended information, and the receiving of the feedback information for the modified recommended information.

11. The method of claim 9, further comprising:
updating a database (DB) storing use pattern information of the one or more clients in the proposal service operating apparatus by reflecting the received feedback information.

12. The method of claim 9, further comprising:
configuring a population with candidate entities included in a specific service field,
wherein the generating of the recommended information performs at least one of:
re-producing the candidate entities in a combination of a binary number and generating proposal entities,
generating modified proposal entities by crossing or mutating the proposal entities; and
generating modified proposal entities by reflecting the feedback information.

13. The method of claim 9, further comprising:
selecting the recommended information according to a fitness score of the recommended information or the modified recommended information based on the feedback information.

14. The method of claim 13, wherein the selecting includes:
calculating the fitness score of the recommended information or the modified recommended information based on the feedback information; and
when the fitness score of the recommended information or the modified recommended information meets a predetermined reference value, selecting the recommended information as a candidate for generating next recommended information, and, when the fitness score of the recommended information or the modified recommended information does not meet the predetermined reference value, excluding the recommended information from a candidate for generating next recommended information.

15. A method of operating a proposal service by an electronic device, the method comprising:
receiving recommended information from a proposal service apparatus in response to a recommended information request event;
providing the recommended information; and
when feedback information about the recommended information is detected from a user, transferring the received feedback information to the proposal service apparatus.
